(19) United States
(12) Patent Application Publication
(10) Pub. No.: US 2022/0082040 A1
(43) Pub. Date: Mar. 17, 2022

(54) LANCE INJECTOR ASSEMBLY WITH HEATING ELEMENT

(71) Applicant: Cummins Emission Solutions Inc., Columbus, IN (US)

(72) Inventors: Gaurav Hemant Pandit, Columbus, IN (US); Christopher Dobbins, Columbus, IN (US); Padmanabha Reddy Ettireddy, Columbus, IN (US); Stephen M. Holl, Columbus, IN (US); John G. Buechler, Indianapolis, IN (US)

(73) Assignee: Cummins Emission Solutions Inc., Columbus, IN (US)

(21) Appl. No.: 17/471,743

(22) Filed: Sep. 10, 2021

Related U.S. Application Data
(60) Provisional application No. 63/077,901, filed on Sep. 14, 2020.

(51) Int. Cl. F01N 3/20

(52) U.S. Cl. CPC F01N 3/208; F01N 2570/14; F01N 2610/02; F01N 2900/1404; F01N 2610/105; F01N 2610/1453; F01N 2610/06

(57) ABSTRACT

A lance injector assembly for an aftertreatment system comprises a shaft configured to extend into an exhaust conduit of the aftertreatment system, the shaft being hollow so as to define a cavity. A supply line is disposed within the cavity defined by the shaft. The supply line is configured to receive a liquid reductant, and an outlet of the supply line is fluidly coupled to an opening defined in the shaft. A heating element is located in the cavity and configured to selectively heat the liquid reductant flowing through the supply line to generate gaseous reductant to be expelled from the outlet of the supply line.

### CROSS-REFERENCE TO RELATED APPLICATIONS

The present application claims the benefit of U.S. Provisional Application No. 63/077,901, filed Sep. 14, 2020, the entire disclosure of which is incorporated by reference herein.

### TECHNICAL FIELD

The present application relates generally to systems and methods for reductant delivery in aftertreatment systems for internal combustion engines.

### BACKGROUND

Exhaust aftertreatment systems are used to receive and treat exhaust gas generated by internal combustion engines. Generally, exhaust gas aftertreatment systems include any of several different components to reduce the levels of harmful exhaust emissions present in the exhaust gas. For example, certain exhaust gas aftertreatment systems for diesel-powered internal combustion engines include a selective catalytic reduction (SCR) system including a catalyst formulated to convert NOx (NO and NO₂ in some fraction) into harmless nitrogen gas (N₂) and water vapor (H₂O) in the presence of ammonia (NH₃). Generally in such aftertreatment systems, an exhaust reductant, (e.g., a diesel exhaust fluid such as urea) is injected into the SCR system to provide a source of ammonia, and mixed with the exhaust gas to partially reduce the NOx gases. The reduction byproducts of the exhaust gas are then fluidly communicated to the catalyst included in the SCR system to decompose substantially all of the NOx gases into relatively harmless byproducts which are expelled out of the aftertreatment system.

### SUMMARY

Embodiments described herein relate generally to aftertreatment systems that include a lance injector assembly for inserting gaseous reductant into an exhaust conduit of the aftertreatment system and in particular, to lance injector assemblies that include a heating element configured to heat liquid reductant flowing through the lance injector assembly so as to generate gaseous reductant which is inserted into the exhaust conduit.

In some embodiments, a lance injector assembly for an aftertreatment system comprises: a shaft configured to extend into an exhaust conduit of the aftertreatment system, the shaft being hollow so as to define a cavity; a supply line disposed within the cavity defined by the shaft, wherein the supply line is configured to receive a liquid reductant, and wherein an outlet of the supply line is fluidly coupled to an opening defined in the shaft; and a heating element located in the cavity and configured to selectively heat the liquid reductant flowing through the supply line to generate gaseous reductant to be expelled from the outlet of the supply line.

In some embodiments, an aftertreatment system comprises: a selective catalytic reduction catalyst configured to treat constituents of an exhaust gas; and a dosing module configured to insert a reductant into the exhaust gas upstream of the selective catalytic reduction catalyst, the dosing module comprising a lance injector assembly comprising: a shaft, the shaft being hollow so as to define a cavity, a supply line disposed within the cavity defined by the shaft, wherein the supply line is configured to receive a liquid reductant, and wherein an outlet of the supply line is fluidly coupled to an opening defined in the shaft, and a heating element located in the cavity and configured to selectively heat the liquid reductant flowing through the supply line to generate gaseous reductant to be expelled from the outlet of the supply line.

In some embodiments, a method for inserting a reductant into an aftertreatment system comprises: providing an aftertreatment system comprising an exhaust conduit and a dosing module, wherein the dosing module comprises a lance injector assembly comprising: a shaft configured to extend into the exhaust conduit, the shaft being hollow so as to define a cavity, a supply line disposed within the cavity defined by the shaft, wherein the supply line is configured to receive a liquid reductant, and wherein an outlet of the supply line is fluidly coupled to an opening defined in the shaft, and a heating element located in the cavity and configured to selectively heat the liquid reductant flowing through the supply line; determining, by a controller, whether there is a demand for a reductant to be inserted into an exhaust gas flowing through the exhaust conduit, in response to a demand for the reductant being present, determining, by a controller, a temperature of the exhaust gas; in response to the determining that the temperature is equal to or less than a threshold, causing, by the controller, activation of the heating element; and commanding, by the controller, a dosing module to insert a liquid reductant through the supply line, such that the heating element heats the liquid reductant to generate a gaseous reductant.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a schematic block diagram of an example aftertreatment system, according to an embodiment.

FIG. 2 is schematic illustration of a portion of the aftertreatment system of FIG. 1 showing a lance injector assembly included in the aftertreatment system, according to an embodiment.

FIG. 3 is a schematic block diagram of a controller included in the aftertreatment system of claim 1, according to an embodiment.

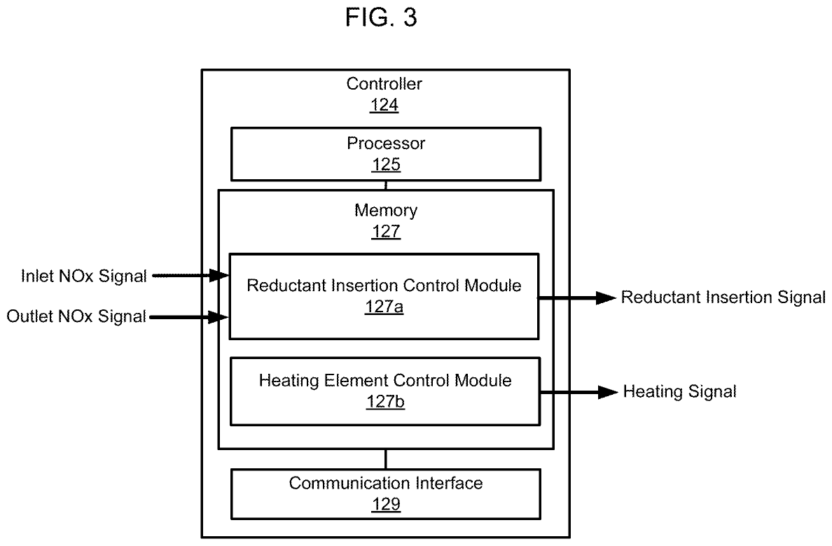

FIG. 4 is a schematic flow diagram of a method for inserting gaseous reductant into an aftertreatment system, according to an embodiment.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Embodiments described herein relate generally to aftertreatment systems that include a lance injector assembly for inserting gaseous reductant into an exhaust conduit of the aftertreatment system and in particular, to lance injector assemblies that include a heating element configured to heat liquid reductant flowing through the lance injector assembly so as to generate gaseous reductant which is inserted into the exhaust conduit.

Conventional lance injector assemblies or reductant injectors are structured to insert a liquid reductant into aftertreatment systems. Such conventional lance injector assemblies generally have a low Uniformity Index (“UP”) and are prone to reductant deposit formation. In contrast, various embodiments of the lance injector assemblies described herein may provide one or more benefits including, for example: 1) allowing delivery of gaseous ammonia into the exhaust gas, thereby facilitating mixing of the reductant into the exhaust gas and increasing UI; (2) inhibiting formation of reductant deposits that can occur due to impingement of liquid reductant on internal surfaces of the aftertreatment system, or form on a nozzle of the lance injector assembly; (3) reducing backpressure exerted by a mixer disposed downstream of the lance injector assembly by causing mixing of two gases instead of mixing of a liquid reductant with the exhaust gas; (4) reducing complexity of downstream mixers; and (5) reducing maintenance costs.

Following below are more detailed descriptions of various concepts related to, and implementations of, methods, apparatuses, and systems for delivering reductant through conduits within an aftertreatment system. The various concepts introduced above and discussed in greater detail below may be implemented in any of numerous ways, as the described concepts are not limited to any particular manner of implementation. Examples of specific implementations and applications are provided primarily for illustrative purposes.

### I. OVERVIEW

Internal combustion engines (e.g., diesel internal combustion engines, etc.) produce exhaust gases that are often treated by a doser or reductant injector within an aftertreatment system. Dosers typically treat exhaust gases using a reductant. The reductant is typically provided from the doser into a lance injector which distributes (e.g., doses, injects) the reductant into an exhaust stream within an exhaust component.

Centerline-style lance injectors that extend to the approximate centerline of an exhaust pipe provide several advantages over tangential or side mount dosers, which may incur problems with impingement or deposit formation inside the mixer and low inherent uniformity in the reductant spray. Many centerline-style dosing systems utilize an air pump to propel the reductant from the lance injector into the exhaust stream. The air pump may draw air from an air source (e.g., air intake) and provide air to a lance injector that is configured to mix the air and reductant into an air-reductant mixture. However, the inclusion of an air pump for this purpose may add unnecessary cost and complexity to the aftertreatment system. In some vehicles, the addition of an air supply system may be impossible.

Implementations described herein relate to an exhaust aftertreatment system that includes a liquid only (i.e., airless) lance injector. Existing liquid only lance injector systems utilize tangential or side mount dosers to protect the doser actuation valve from the high heat conditions experienced within the exhaust stream, which may include temperatures up to 650° C. The centerline-style doser embodiments described herein locate any sensitive actuator components outside of the flow the exhaust gas and use a heating element to generate gaseous reductant that is inserted into the aftertreatment system with high uniformity. In addition, the embodiments described herein may include hydrolysis catalysts to facilitate conversion hydrolysis of decomposition byproducts of the gaseous reductant into ammonia.

### II. OVERVIEW OF AFTERTREATMENT SYSTEM

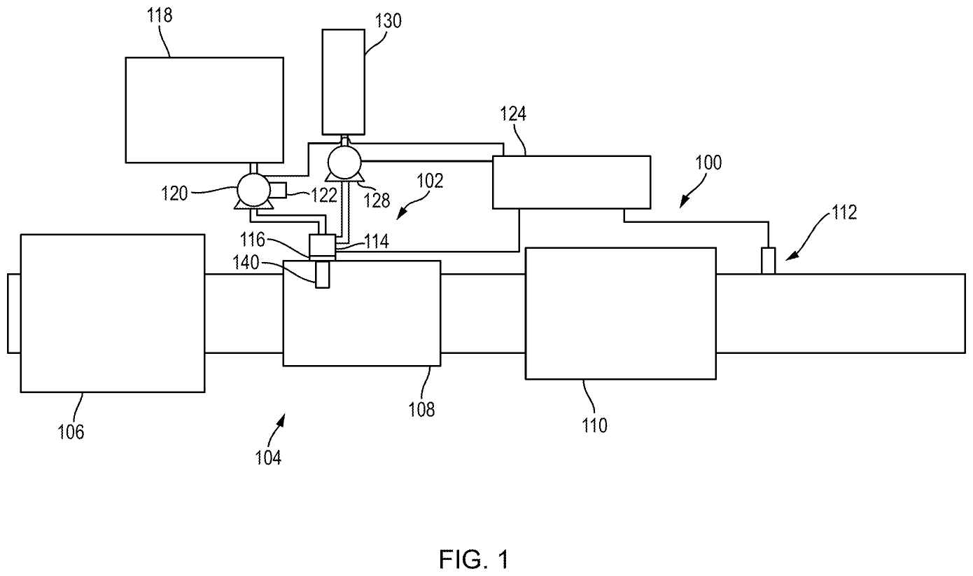

FIG. 1 depicts an aftertreatment system 100 having an example reductant delivery system 102 for an exhaust system 104. The aftertreatment system 100 also includes a particulate filter (e.g., a diesel particulate filter (DPF)) 106, a decomposition chamber 108 (e.g., reactor, reactor pipe, etc.), a SCR catalyst 110, and a sensor 112.

The DPF 106 is configured to (e.g., structured to, able to, etc.) remove particulate matter, such as soot, from exhaust gas flowing in the exhaust system 104. The DPF 106 includes an inlet, where the exhaust gas is received, and an outlet, where the exhaust gas exits after having particulate matter substantially filtered from the exhaust gas and/or converting the particulate matter into carbon dioxide. In some implementations, the DPF 106 may be omitted.

The decomposition chamber 108 is configured to convert a reductant into ammonia. The reductant may be, for example, urea, diesel exhaust fluid (DEF), Adblue®, an urea water solution (UWS), an aqueous urea solution (e.g., AUS32, etc.), and other similar fluids. For example, the reductant may comprise an aqueous urea solution having a particular ratio of urea to water. In particular embodiments, the reductant can comprise an aqueous urea solution including 32.5% by volume of urea and 67.5% by volume of deionized water, including 40% by volume of urea and 60% by volume of deionized water, or any other suitable ratio of urea to deionized water.

The decomposition chamber 108 includes a reductant delivery system 102 having a doser or dosing module 114 configured to dose the reductant into the decomposition chamber 108 (e.g., via an injector). In some implementations, the reductant is injected upstream of the SCR catalyst 110. The reductant droplets then undergo the processes of evaporation, thermolysis, and hydrolysis to form gaseous ammonia within the exhaust system 104. The decomposition chamber 108 includes an inlet in fluid communication with the DPF 106 to receive the exhaust gas containing NOx emissions and an outlet for the exhaust gas, NOx emissions, ammonia, and/or reductant to flow to the SCR catalyst 110.

The decomposition chamber 108 includes the dosing module 114 mounted to the decomposition chamber 108 such that the dosing module 114 may dose the reductant into the exhaust gases flowing in the exhaust system 104. The dosing module 114 may include an insulator 116 interposed between a portion of the dosing module 114 and the portion of the decomposition chamber 108 on which the dosing module 114 is mounted. The dosing module 114 is fluidly coupled to (e.g., fluidly configured to communicate with, etc.) a reductant source 118. The reductant source 118 may include multiple reductant sources 118. The reductant source 118 may be, for example, a diesel exhaust fluid tank containing Adblue®.

A supply unit or reductant pump 120 is used to pressurize the reductant from the reductant source 118 for delivery to the dosing module 114. In some embodiments, the reductant pump 120 is pressure controlled (e.g., controlled to obtain a target pressure, etc.). The reductant pump 120 includes a filter 122. The filter 122 filters (e.g., strains, etc.) the reductant prior to the reductant being provided to internal components (e.g., pistons, vanes, etc.) of the reductant pump 120. For example, the filter 122 may inhibit or prevent the transmission of solids (e.g., solidified reductant, contaminants, etc.) to the internal components of the reductant pump 120. In this way, the filter 122 may facilitate prolonged desirable operation of the reductant pump 120. In some embodiments, the reductant pump 120 is coupled to a chassis of a vehicle (e.g., maritime vehicle, boat, shipping boat, barge, container ship, terrestrial vehicle, construction vehicle, truck, etc.) associated with the aftertreatment system 100.

The dosing module 114 and reductant pump 120 are also electrically or communicatively coupled to a controller 124. The controller 124 is configured to control the dosing module 114 to dose the reductant into the decomposition chamber 108. The controller 124 may also be configured to control the reductant pump 120. The controller 124 may include a microprocessor, an application-specific integrated circuit (ASIC), a field-programmable gate array (FPGA), etc., or combinations thereof. The controller 124 may include memory, which may include, but is not limited to, electronic, optical, magnetic, or any other storage or transmission device capable of providing a processor, ASIC, FPGA, etc. with program instructions. This memory may include a memory chip, Electrically Erasable Programmable Read-Only Memory (EEPROM), Erasable Programmable Read Only Memory (EPROM), flash memory, or any other suitable memory from which the associated controller 124 can read instructions. The instructions may include code from any suitable programming language.

The SCR catalyst 110 is configured to assist in the reduction of NOx emissions by accelerating a NOx reduction process between the ammonia and the NOx of the exhaust gas into diatomic nitrogen, water, and/or carbon dioxide. The SCR catalyst 110 includes an inlet in fluid communication with the decomposition chamber 108 from which exhaust gas and reductant are received and an outlet in fluid communication with an end of the exhaust system 104.

The exhaust system 104 may further include an oxidation catalyst (e.g., a diesel oxidation catalyst (DOC)) in fluid communication with the exhaust system 104 (e.g., downstream of the SCR catalyst 110 or upstream of the DPF 106) to oxidize hydrocarbons and carbon monoxide in the exhaust gas. In some implementations, the DPF 106 may be positioned downstream of the decomposition chamber 108. For instance, the DPF 106 and the SCR catalyst 110 may be combined into a single unit. In some implementations, the dosing module 114 may instead be positioned downstream of a turbocharger or upstream of a turbocharger.

The sensor 112 may be coupled to the exhaust system 104 to detect a condition of the exhaust gas flowing through the exhaust system 104. In some implementations, the sensor 112 may have a portion disposed within the exhaust system 104; for example, a tip of the sensor 112 may extend into a portion of the exhaust system 104. In other implementations, the sensor 112 may receive exhaust gas through another conduit, such as one or more sample pipes extending from the exhaust system 104. While the sensor 112 is depicted as positioned downstream of the SCR catalyst 110, it should be understood that the sensor 112 may be positioned at any other position of the exhaust system 104, including upstream of the DPF 106, within the DPF 106, between the DPF 106 and the decomposition chamber 108, within the decomposition chamber 108, between the decomposition chamber 108 and the SCR catalyst 110, within the SCR catalyst 110, or downstream of the SCR catalyst 110. In addition, two or more sensors 112 may be utilized for detecting a condition of the exhaust gas, such as two, three, four, five, or six sensors 112 with each sensor 112 located at one of the aforementioned positions of the exhaust system 104.

The dosing module 114 includes a lance injector assembly 140. The dosing module 114 may include a delivery conduit (e.g., delivery pipe, delivery hose, etc.). The delivery conduit is fluidly coupled to the reductant pump 120. The dosing module 114 includes at least one injector 128. The injector 128 is configured to dose the reductant into the exhaust gases (e.g., within the decomposition chamber 108, etc.) via the lance injector assembly 140. While not shown, it is understood that the dosing module 114 may include a plurality of injectors 128. Various embodiments of lance injector assemblies than can be used in the aftertreatment system 100 and/or describe structures that can be incorporated into the lance injector assemblies described herein, are disclosed in U.S. patent application Ser. No. 16/909,010, filed Jun. 23, 2020, the entire disclosure of which is incorporated by reference herein.

### III. LANCE INJECTOR ASSEMBLY WITH HEATING ELEMENT

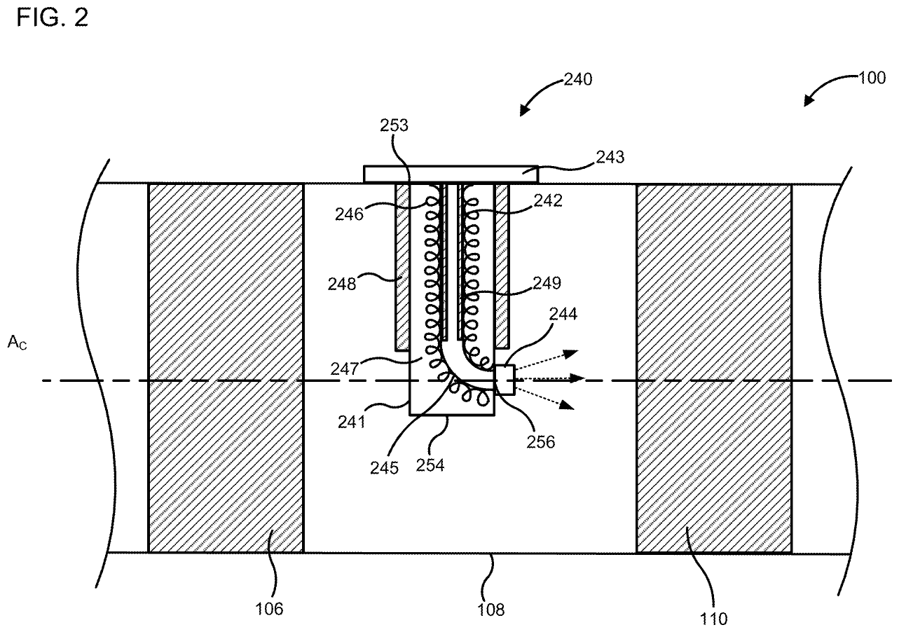

FIG. 2 is a schematic illustration of a portion of the aftertreatment system of FIG. 1 showing a lance injector assembly 240 that may be used for inserting gaseous reductant into the aftertreatment system 100. The lance injector assembly 240 includes a shaft 241, a supply line 242, a heating element 246 located in the cavity 247, and optionally a cap 243, an insulating layer 248, and a hydrolysis catalyst layer 249. For example, the heating element 246 may be coupled to the supply line 242.

The shaft 241 is configured to extend into the decomposition chamber 108 of the aftertreatment system 100. The shaft 241 is hollow so as to define a cavity 247. The shaft 241 may have an inner diameter in a range of 0.5 inches to 1.5 inches (e.g., 0.5, 0.6, 0.7, 0.8, 0.9, 1.0, 1.1, 1.2, 1.3, 1.4, or 1.5 inches, inclusive). Air is present between the shaft 241 and the supply line 242 such that air insulation is provided around the supply line 242 which inhibits heat transfer from the shaft 241 to the supply line 242 and the reductant flowing therethrough. Thus, the lance injector assembly is configured to provide air insulation to reductant flowing through the supply line 242 of the lance injector assembly 240 such that liquid cooling (e.g., reductant return cooling lines) are not used. A first end 253 of the shaft 241 is located proximate to a sidewall of the decomposition chamber 108 and a second end 254 of the shaft 241 is located proximate to a central axis Ac of the decomposition chamber 108. An opening 256 is defined in the shaft 241. As shown in FIG. 2, the opening 256 may be defined in a wall of the shaft 241 proximate to the second end 254, such that the lance injector assembly 240 is configured to insert reductant along the central axis Ac of the decomposition chamber 108.

A cap 243 may be disposed on and coupled to the first end 253 of the shaft 241. In some embodiments, the cap 243 may have a substantially solid structure. In other embodiments, the cap 243 may include a partially hollow structures. In various embodiments, the cap 243 may include any of the caps defined in the Ser. No. 16/909,010 application and should be understood to be within the scope of the present application. In some embodiments, the cap 243 may be coupled to the sidewall of the decomposition chamber 108. In some embodiments, insulation may be disposed between the cap 243 and the sidewall.

The supply line 242 is disposed within the cavity 247 defined by the shaft 241 and is configured to receive a liquid reductant. An outlet of the supply line 242 is fluidly coupled to the opening 256 defined in the shaft 241. The supply line 242 may extend through the cap 243. A bend 245 (e.g., an elbow) is defined in the supply line 242 such that a portion of the supply line 242 that is located proximate to the second end 254 of the shaft 241, is substantially perpendicular to an upstream portion of the supply line 242. Since the shaft 241 provides air insulation around the supply line 242, there is no thermal mass in the bend 245. As shown in FIG. 2, the lance supply line 242 does not include a check valve.

The lance injector assembly 240 further comprises a nozzle 244 fluidly coupled to the outlet of the supply line 242. The nozzle 244 is coupled to the shaft 241 (e.g., welded to the shaft 241) around the opening 256 such that gaseous reductant is able to flow from the opening to the nozzle 244, and from the nozzle 244 into an exhaust gas flowing through the decomposition chamber 108. In some embodiments, the nozzle 244 is disposed on or defined by an adapter that is coupled to the outlet of the supply line 242. The adapter may be coupled fluidly coupled to or alternatively, may extend through the opening 256 defined in a wall of the shaft 241. In some embodiments, the opening 256 may be defined at a distance of about 1 inches to 2 inches from the second end 254 of the shaft 241 (e.g., between 1.0, 1.1, 1.2, 1.3, 1.4, 1.5, 1.6, 1.7, 1.8, 1.9, or 2.0 inches, inclusive). Various embodiments of adapters that may be used in the lance injector assembly 240 are described in the Ser. No. 16/909,010 application and should be understood to be within the scope of the present application.

A heating element 246 is located in the cavity 247 (e.g., disposed around the supply line 242) and configured to selectively heat the liquid reductant flowing through the supply line 242 to generate gaseous reductant that is expelled from the outlet of the supply line 242, and therefore from the nozzle 244, into the exhaust gas flowing through the decomposition chamber 108. The heating element 246 may be configured to heat the reductant to a temperature sufficient to decompose (e.g., thermolyze) the liquid reductant to generate a gaseous reductant, for example, a mixture of NH₃ and HNCO, or generate pure NH₃. In some embodiments, the heating element 246 is configured to heat the reductant to a temperature in a range of 600 degrees Celsius to 1,000 degrees Celsius that may be sufficient to decompose the reductant to generate gaseous ammonia. The heating element 246 may include a heating coil, a heating strip, or any other suitable heating element.

In some embodiments, a hydrolysis catalyst layer 249 may be disposed (e.g., coated) on at least a portion of an internal surface of the supply line 242. The hydrolysis catalyst layer 249 may be formulated to catalyze conversion of HNCO to NH₃. Such that the gaseous reductant expelled from the nozzle 244 into the exhaust gas is composed substantially of NH₃ (e.g., greater than 95% NH₃). In some embodiments, the lance injector assembly 240 may also include an insulating layer 248 disposed on the shaft 241, for example, around an outer surface of the shaft 241 or on an inner surface of the shaft 241, and configured to limit heat transfer from an environment outside of the shaft 241 to the supply line 242.

In some embodiments, the insulating layer 248 may help retain heat within the shaft 241 when the exhaust temperatures are low (e.g., at engine startup). This may reduce the amount of heat used to decompose the liquid reductant into gaseous reductant, particularly at lower exhaust gas temperatures where the catalytic conversion efficiency of the SCR catalyst 110 is low (e.g., when a temperature of the exhaust gas is equal to or lower than 200 degrees Celsius.) In such instances, the insulating layer 248 may inhibit any cooling of the lance injector assembly 240 by the lower temperature exhaust gas. Thus, the amount of heat used to decompose the liquid reductant to gaseous reductant will be lower than the heat used to achieve NH₃ generation, and hence NOx reduction, relative to the liquid reductant when no insulating layer is used. The insulating layer 248 may also inhibit reductant crystallization and thereby, reductant deposit formation when the exhaust gas temperature is too high (e.g., by inhibiting heat transfer into the shaft 241.)

In various embodiments, the lance injector assembly 240 may be configured to provide a reductant flow rate in a range of 0.1 ml/second to 1.0 ml/second, inclusive. In some embodiments, the length of the supply line 242 may be in a range of 6 inches to 10 inches (e.g., 6, 7, 8, 9, or 10 inches, inclusive), a diameter of the supply line 242 may be in a range of 2 mm to 6 mm (e.g., 2, 3, 4, 5, or 6 mm, inclusive), and a surface area of the supply line 242 may be in a range of 20 cm² to 30 cm² (e.g., 20, 22, 24, 26, 28, or 30 cm², inclusive). The supply line 242 may be able to support a reductant velocity in a range of 0.01 m/second to 0.1 m/second (e.g., 0.01, 0.02, 0.03, 0.04, 0.05, 0.06, 0.07, 0.08, 0.09, or 0.1 m/second, inclusive). In some embodiments, the power generated by the heating element 246 to complete vaporize the reductant flowing through the supply line 242 may be in a range of 0.4 kW to 2.2 kW (e.g., 0.4, 0.6, 0.8, 1.0, 1.2, 1.4, 1.6, 1.8, 2.0, 2.2, or 2.4 kW, inclusive) and a power density may be in a range of 15 kW/cm² to 85 kW/cm² (e.g., 15, 20, 25, 30, 35, 40, 45, 50, 55, 60, 65, 70, 75, 80, or 85 kW/cm², inclusive).

As described above, the lance injector assembly 240 does not include DEF coolant lines. This reduces complexity of the lance injector assembly 240, reduces manufacturing cost, inhibits temperature increase in an upstream reductant storage tank which may happen due to return of heated reductant via reductant return lines, and removes problems with failure of lance injector assemblies due to reductant deposit formation in reductant return lines. Additionally, the lance injector assembly 240 does not include a solid elbow and instead, include an empty air cavity 247 to reduce the thermal mass and hence, improve thermal performance. Moreover, cost is further reduced by excluding a check valve which beneficially also reduces thermal mass.

In some embodiments, the controller 124 may be coupled to the dosing module 114 and the heating element 246 and configured to selectively activate the heating element 246 for decomposing the liquid reductant flowing through the supply line 242. For example, the sensor 112 may include a temperature sensor configured to determine a temperature of the exhaust gas flowing through the decomposition chamber 108. In some embodiments, the sensor 112 may include a NOx sensor configured to determine an amount of NOx gases in the exhaust gas at an inlet and/or outlet of the aftertreatment system 100. The controller 124 may be configured to receive a temperature signal from the sensor 112 and determine the temperature of the exhaust gas. The controller 124 may be coupled to the sensor 112, to the dosing module 114, to the heating element 246, or any other component of the aftertreatment system 100, for example, a wired connection may include a serial cable, a fiber optic cable, a CAT5 cable, or any other form of wired connection. Wireless connections may include the Internet, Wi-Fi, cellular, radio, Bluetooth, ZigBee, etc. In one embodiment, a controller area network (CAN) bus provides the exchange of signals, information, and/or data. The CAN bus includes any number of wired and wireless connections.

The controller 124 may be configured to determine whether there is a demand for reductant to be inserted into the aftertreatment system 100. For example, the controller 124 may receive an inlet and/or an outlet NOx signal from the sensor 112 and determine whether there is a demand for reductant based on the determined amount of NOx gases in the exhaust gas at the inlet and/or outlet of the aftertreatment system 100.

In some embodiments, in response to determining that there is a demand for a reductant, the controller 124 may be configured to activate the heating element 246 to decompose (e.g., thermolyze) the reductant flowing through the supply line 242 and insert gaseous reductant (e.g., NH₃+HNCO, or NH₃) into the exhaust gas. In other embodiments, the controller 124 may be configured to determine a temperature of the exhaust gas, for example, based on a temperature signal received from the temperatures sensor 112. In response to the temperature of the exhaust gas being greater than a threshold (e.g., 250 degrees Celsius), the controller 124 may be configured to activate the dosing module 114 to insert liquid reductant though the lance injector assembly 240 into the exhaust gas. The threshold may correspond to a temperature which is sufficient to decompose substantially all of the reductant into NH₃. In response to the temperature being equal to or less than the temperature threshold, the controller 124 may be configured to activate the heating element 246 so as to decompose the reductant within the supply line 242 such that gaseous ammonia is expelled from lance injector assembly 240 into the exhaust gas.

In particular embodiments, the controller 124 may include a plurality of modules. The controller 124 comprises a processor 125, a memory 127, or any other computer readable medium, and a communication interface 129. Furthermore, the controller 124 includes a reductant insertion control module 127a and a heating element control module 127b. It should be understood that the controller 124 shows only one embodiment of the controller 124 and any other controller capable of performing the operations described herein can be used.

The processor 125 can comprise a microprocessor, programmable logic controller (PLC) chip, an ASIC chip, or any other suitable processor. The processor 125 is in communication with the memory 127 and configured to execute instructions, algorithms, commands, or otherwise programs stored in the memory 127.

The memory 127 comprises any of the memory and/or storage components discussed herein. For example, memory 127 may comprise a RAM and/or cache of processor 125. The memory 127 may also comprise one or more storage devices (e.g., hard drives, flash drives, computer readable media, etc.) either local or remote to controller 124. The memory 127 is configured to store look up tables, algorithms, or instructions.

In one configuration, the reductant insertion control module 127a and the heating element control module 127b are embodied as machine or computer-readable media (e.g., stored in the memory 127) that is executable by a processor, such as the processor 125. As described herein and amongst other uses, the machine-readable media (e.g., the memory 127) facilitates performance of certain operations to enable reception and transmission of data. For example, the machine-readable media may provide an instruction (e.g., command, etc.) to, e.g., acquire data. In this regard, the machine-readable media may include programmable logic that defines the frequency of acquisition of the data (or, transmission of the data). Thus, the computer readable media may include code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, etc.).

In another configuration, the reductant insertion control module 127a and the heating element control module 127b are embodied as hardware units, such as electronic control units. As such, the reductant insertion control module 127a and the heating element control module 127b may be embodied as one or more circuitry components including, but not limited to, processing circuitry, network interfaces, peripheral devices, input devices, output devices, sensors, etc.

In some embodiments, the reductant insertion control module 127a and the heating element control module 127b may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the reductant insertion control module 127a and the heating element control module 127b may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on.

Thus, the reductant insertion control module 127a and the heating element control module 127b may also include programmable hardware devices such as field programmable gate arrays, programmable array logic, programmable logic devices or the like. In this regard, the reductant insertion control module 127a and the heating element control module 127b may include one or more memory devices for storing instructions or algorithms that are executable by the processor(s) of the reductant insertion control module 127a and the heating element control module 127b. The one or more memory devices and processor(s) may have the same definition as provided below with respect to the memory 127 and the processor 125.

In the example shown, the controller 124 includes the processor 125 and the memory 127. The processor 125 and the memory 127 may be structured or configured to execute or implement the instructions, commands, and/or control processes described herein with respect to the reductant insertion control module 127a and the heating element control module 127b. Thus, the depicted configuration represents the aforementioned arrangement the reductant insertion control module 127a and the heating element control module 127b are embodied as machine or computer-readable media. However, as mentioned above, this illustration is not meant to be limiting as the present disclosure contemplates other embodiments such as the aforementioned embodiment where the reductant insertion control module 127a and the heating element control module 127b, or the reductant insertion control module 127a and the heating element control module 127b are configured as a hardware unit. All such combinations and variations are intended to fall within the scope of the present disclosure.

The processor 125 may be implemented as one or more general-purpose processors, an application specific integrated circuit (ASIC), one or more field programmable gate arrays (FPGAs), a digital signal processor (DSP), a group of processing components, or other suitable electronic processing components. In some embodiments, the one or more processors may be shared by multiple circuits (e.g., the reductant insertion control module 127a and the heating element control module 127b) may comprise or otherwise share the same processor which, in some example embodiments, may execute instructions stored, or otherwise accessed, via different areas of memory). Alternatively, or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure. The memory 127 (e.g., RAM, ROM, Flash Memory, hard disk storage, etc.) may store data and/or computer code for facilitating the various processes described herein. The memory 127 may be communicably connected to the processor 125 to provide computer code or instructions to the processor 125 for executing at least some of the processes described herein. Moreover, the memory 127 may be or include tangible, non-transient volatile memory or non-volatile memory. Accordingly, the memory 127 may include database components, object code components, script components, or any other type of information structure for supporting the various activities and information structures described herein.

The communication interface 129 may include wireless interfaces (e.g., jacks, antennas, transmitters, receivers, communication interfaces, wire terminals, etc.) for conducting data communications with various systems, devices, or networks. For example, the communication interface 129 may include an Ethernet card and port for sending and receiving data via an Ethernet-based communications network and/or a Wi-Fi communication interface for communicating with the sensor 112, the dosing module 114, the heating element 246 or another components of the aftertreatment system 100. The communication interface 129 may be structured to communicate via local area networks or wide area networks (e.g., the Internet, etc.) and may use a variety of communications protocols (e.g., IP, LON, Bluetooth, ZigBee, radio, cellular, near field communication, etc.).

The reductant insertion control module 127a is configured to receive in inlet NOx signal and an outlet NOx signal (e.g., from the sensor 112) and determine if there is a demand for a reductant to be inserted into the exhaust gas. In response to a demand being present, the reductant insertion control module 127a is configured to generate a reductant insertion signal to activate the dosing module 114 for providing a liquid reductant to the lance injector assembly 240. The heating element control module 127b is configured to generate a heating signal to activate the heating element 246, for example, in response to the temperature of the exhaust gas being less than the threshold, so as to decompose the liquid reductant flowing through the supply line 242 and generate gaseous reductant.

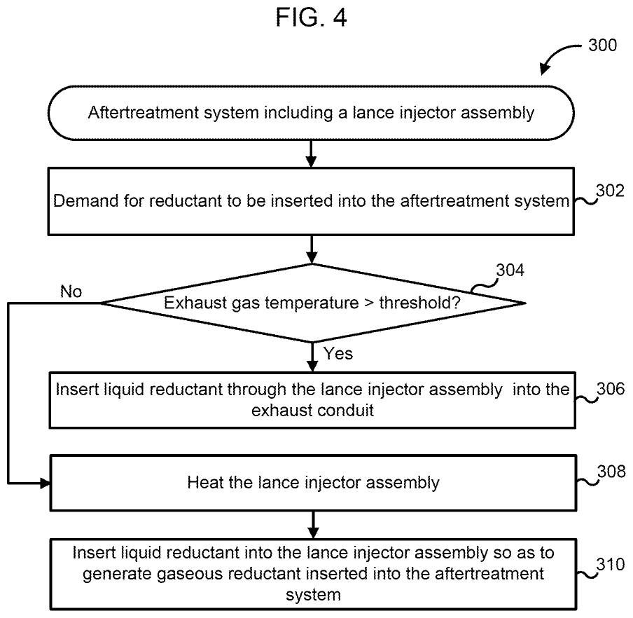

FIG. 4 is a schematic flow diagram of a method 300 for selectively inserting a gaseous reductant into a decomposition chamber (e.g., the decomposition chamber 108) of an aftertreatment system (e.g., the aftertreatment system 100) using a lance injector assembly that includes a heating element (e.g., the lance injector assembly 240). While various operations of the method are described with respect to the aftertreatment system 100 and the controller 124, the operations of the method 300 can be implemented in any controller included in any aftertreatment system that includes a lance injector assembly with a heating element.

The method 300 includes determining, by the controller 124, that there is a demand for a reductant to be inserted into the aftertreatment system 100, at 302. The reductant demand may be determined based on an inlet amount and/or an outlet amount of NOx gases included in the exhaust gas flowing through the aftertreatment system 100.

At 304, the controller 124 determines if a temperature of the exhaust gas is greater than a threshold (e.g., 250 degrees Celsius), for example, based on a temperature signal received from the sensor 112. In some embodiments, in response to the controller 124 determining that the temperature is greater than the threshold (304:YES), the controller 124 commands the dosing module 114 to insert liquid reductant through the supply line 242 of the lance injector assembly 240 into the exhaust gas flowing through the decomposition chamber 108, at 306.

In response to the temperature of the exhaust gas being equal to or less than the threshold (304:NO), the controller 124 activates the heating element 246, at 308. At 310, the controller 124 commands the dosing module 114 to insert liquid reductant through the lance injector assembly 240. As the liquid reductant passes through the supply line 242, the reductant decomposes due to the heat provided by the heating element 246 generating gaseous reductant (e.g., NH₃+HNCO or NH₃) which is inserted into the exhaust gas via the supply line 242.

### IV. CONSTRUCTION OF EXAMPLE EMBODIMENTS

As utilized herein, the terms “substantially,” generally,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The terms “coupled,” “attached,” “fastened,” “fixed,” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another, with the two components, or with the two components and any additional intermediate components being attached to one another.

The terms “fluidly coupled,” “fluidly communicable with,” and the like, as used herein, mean the two components or objects have a pathway formed between the two components or objects in which a fluid, such as air, liquid reductant, gaseous reductant, aqueous reductant, gaseous ammonia, etc., may flow, either with or without intervening components or objects. Examples of fluid couplings or configurations for enabling fluid communication may include piping, channels, or any other suitable components for enabling the flow of a fluid from one component or object to another.

It is important to note that the construction and arrangement of the system shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the application, the scope being defined by the claims that follow. When the language “a portion” is used, the item can include a portion and/or the entire item unless specifically stated to the contrary. It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples)

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Additionally, it should be understood that features from one embodiment disclosed herein may be combined with features of other embodiments disclosed herein as one of ordinary skill in the art would understand. Other substitutions, modifications, changes and omissions may also be made in the design, operating conditions and arrangement of the various exemplary embodiments without departing from the scope of the present invention.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A lance injector assembly for an aftertreatment system comprising:
a shaft configured to extend into an exhaust conduit of the aftertreatment system, the shaft being hollow so as to define a cavity;
a supply line disposed within the cavity defined by the shaft, wherein the supply line is configured to receive a liquid reductant, and wherein an outlet of the supply line is fluidly coupled to an opening defined in the shaft; and
a heating element located in the cavity and configured to selectively heat the liquid reductant flowing through the supply line to generate gaseous reductant to be expelled from the outlet of the supply line.

2. The lance injector assembly of claim 1, wherein:
a first end of the shaft is located proximate to a sidewall of the exhaust conduit and a second end of the shaft is located proximate to a central axis of the exhaust conduit, the opening being defined in a wall of the shaft proximate to the second end; and
the lance injector assembly further comprises a nozzle fluidly coupled to the outlet of the supply line, the nozzle being coupled to the shaft around the opening such that the gaseous reductant is able to flow through the opening to the nozzle, and from the nozzle into the exhaust conduit.

3. The lance injector assembly of claim 2, wherein the supply line is spaced from the wall of the shaft so as to inhibit heat transfer from an environment outside of the shaft to the supply line.

4. The lance injector assembly of claim 1, further comprising an insulating layer disposed on the shaft.

5. The lance injector assembly of claim 1, further comprising:
a hydrolysis catalyst layer disposed on at least a portion of an inner surface of the supply line.

6. The lance injector assembly of claim 1, further comprising:
a cap disposed on and coupled to a first end of the shaft, the cap configured to be coupled to a sidewall of the exhaust conduit.

7. The lance injector assembly of claim 6, wherein the cap is partially hollow.

8. The lance injector assembly of claim 1, wherein a bend is defined in the supply line such that a portion of the supply line that is located proximate to a second end of the shaft is perpendicular to an upstream portion of the supply line.

9. The lance injector assembly of claim 1, wherein the heating element is configured to generate power in a range of 0.4 kW to 2.4 kW.

10. An aftertreatment system comprising:
a selective catalytic reduction catalyst configured to treat constituents of an exhaust gas; and
a dosing module configured to insert a reductant into the exhaust gas upstream of the selective catalytic reduction catalyst, the dosing module comprising a lance injector assembly comprising:
a shaft, the shaft being hollow so as to define a cavity,
a supply line disposed within the cavity defined by the shaft, wherein the supply line is configured to receive a liquid reductant, and wherein an outlet of the supply line is fluidly coupled to an opening defined in the shaft, and
a heating element located in the cavity and configured to selectively heat the liquid reductant flowing through the supply line to generate gaseous reductant to be expelled from the outlet of the supply line.

11. The aftertreatment system of claim 10, further comprising:
an exhaust conduit, the shaft extending into the exhaust conduit,
wherein:
a first end of the shaft is located proximate to a sidewall of the exhaust conduit, and a second end of the shaft is located proximate to a central axis of exhaust conduit, the opening being defined in a wall of the shaft proximate to the second end; and
the lance injector assembly further comprises a nozzle fluidly coupled to the outlet of the supply line, the nozzle being coupled to the shaft around the opening such that the gaseous reductant is able to flow through the opening to the nozzle, and from the nozzle into the exhaust conduit.

12. The system of claim 11, wherein the supply line is spaced from the wall of the shaft so as to inhibit heat transfer from an environment outside of the shaft to the supply line.

13. The system of claim 11, wherein the lance injector assembly further comprises:
a cap disposed on and coupled to a first end of the shaft, the cap configured to be coupled to a sidewall of the exhaust conduit.

14. The system of claim 10, wherein the lance injector assembly further comprises:
an insulating layer disposed on the shaft.

15. The system of claim 10, wherein the lance injector assembly further comprises:
a hydrolysis catalyst layer disposed on at least a portion of an inner surface of the supply line.

16. The system of claim 10, wherein a bend is defined in the supply line such that a portion of the supply line that is located proximate to a second end of the shaft is perpendicular to an upstream portion of the supply line.

17. The aftertreatment system of claim 10, further comprising:
a controller configured to selectively cause activation of the heating element in response to determining that there is a demand for the gaseous reductant.

18. The aftertreatment system of claim 17, wherein the controller is further configured to:
determine a temperature of the exhaust gas;
wherein the controller is configured to cause activation of the heating element in response to the temperature of the exhaust gas being equal to or less than a temperature threshold.

19. A method for inserting a reductant into an aftertreatment system, comprising:
providing an aftertreatment system comprising an exhaust conduit and a dosing module, wherein the dosing module comprises a lance injector assembly comprising:
a shaft configured to extend into the exhaust conduit, the shaft being hollow so as to define a cavity,
a supply line disposed within the cavity defined by the shaft, wherein the supply line is configured to receive a liquid reductant, and wherein an outlet of the supply line is fluidly coupled to an opening defined in the shaft, and
a heating element located in the cavity and configured to selectively heat the liquid reductant flowing through the supply line;
determining, by a controller, whether there is a demand for a reductant to be inserted into an exhaust gas flowing through the exhaust conduit,
in response to a demand for the reductant being present, determining, by a controller, a temperature of the exhaust gas;
in response to the determining that the temperature is equal to or less than a threshold, causing, by the controller, activation of the heating element; and
commanding, by the controller, a dosing module to insert a liquid reductant through the supply line, such that the heating element heats the liquid reductant to generate a gaseous reductant.

20. The method of claim 19, wherein the lance injector assembly further comprises:
a hydrolysis catalyst layer disposed on at least a portion of an inner surface of the supply line.
